(19) United States
(12) Patent Application Publication
(10) Pub. No.: US 2007/0107310 A1
(43) Pub. Date: May 17, 2007

(54) Stile latch and window assembly incorporating the same

(76) Inventor: Ken Fullick, McHenry, IL (US)

Correspondence Address: Lawrence J. Chapa, 1220 St. William Drive, Libertyville, IL, 60048, US

(21) Appl. No.: 11/270,988

(22) Filed: Nov. 12, 2005

(51) Int. Cl. E05D 15/22

(52) U.S. Cl. 49/185; 49/183

(57) ABSTRACT

A stile latch is provided, which includes a bolt adapted to extend at least partially into a slot, which aligns with the bolt in at least one predefined position along a path of travel of a sash within a frame, while the sash is substantially in plane with the frame, said bolt having a ramped facing, which is adapted to engage an edge of the slot, when the bolt moves from the aligned at least one predefined position toward an unaligned position in at least a first direction of substantially in plane travel. The stile latch further includes a tension device coupled to the bolt, which biases the bolt toward an extended position, and extends the bolt into the slot, when the bolt and the slot are aligned in the at least one predefined position.

### FIELD OF THE INVENTION

The invention pertains to a latch mechanism adapted for use in a sash window assembly. More specifically, the invention pertains to a stile latch, which selectively engages an opening for supporting a sash within a window frame, when the sash is in a predefined non-tilted position within the window frame, wherein the stile latch and the opening are each associated with a respective one of the window frame and a stile of the sash.

### BACKGROUND OF THE INVENTION

Tiltable window assemblies by their very nature are intended to allow a sash to transverse laterally within the plane of the window frame, wherein the existence and the corresponding size of an opening is effected as the sash moves within the frame. In this way a window can move between an open and a closed position. The sash is also generally designed to be able to tilt, such that one end of the sash will tilt out of the frame, and in a direction which is generally inward, relative to a structure like a house.

In many instances, the bottom corners of the sash, when the sash is in either a tilted out of plane position or a non-tilted in-plane position, are maintained substantially in-plane, relative to the frame, by a pair of tilt bars, which are generally received by a corresponding pair of window sash balance shoes, which will generally vertically lock, when the sash is tilted. The window sash balance shoes often reside within partially exposed corresponding tracks in respective ones of the opposite facing side jambs of a window frame, commonly referred to as jamb pockets. The jamb pockets can be formed as part of a jamb liner, which in some instances are formed from an extruded vinyl or plastic. The partial exposure is the result of one or more openings that run at least partially along the length of the frame into which the tilt bar extends, thereby providing access to the jamb pockets, and any properly positioned elements located within the jamb pocket.

The upper corners of the sash are commonly allowed to release from the frame and tilt inward. The upper corners of the sash, in at least some instances, each include a tilt latch, which can be used to generally maintain the sash in a non-tilted position until the tilt latches are selectively released. The tilt latch will commonly include a bolt, which is biased toward an engaged position, that needs to be pulled back from an engaged position to enable the upper portion of the sash to be released and tilt out of the plane of the frame. The end of the bolt in an engaged position will generally extend into a respective one of the same partially exposed jamb pockets into which the tilt bars extend, and more specifically into one of the same one or more openings that run, at least partially, along the length of the frame.

While a window sash generally includes hardware, such as tilt bars and tilt latches, which precludes unintended movement of the sash relative to the window frame, a window can be subjected to extreme conditions, which can exert greater than normal forces, such as high wind forces commonly associated with some storm conditions, for example storms including tornado and hurricane conditions. Window assemblies have increasingly incorporated plastic extruded parts, such as jamb liners, which under most normal conditions provide sufficient structural support, but which can twist and/or flex under more extreme conditions. For example, the jamb liners can deflect when under relatively high levels of stress. Similarly, the top and bottom rails, as well as the stiles of the window sash for many window assemblies are also made from extruded plastic components, which are then welded together at the joints. The plastic extruded top and bottom rails can similarly bow and/or deflect, when significant external forces are applied.

One goal of the window industry is to design windows that can survive ever increasing external forces, while not meaningfully sacrificing the benefits commonly associated with each of the various types of windows. For a tiltable window, this includes the ability of a sash to move within a frame while in plane between an open and a closed position and for a sash to conveniently tilt for access to the external surface of a sash from inside the structure within which the window is installed. The need to be able to tilt the window sash limits the nature and the number of user actuatable support points, which might need to be released to enable the window to be released from the frame. Furthermore, any changes to the window must be balanced relative to the relative cost impact associated with the changes.

Another trend in the industry is toward increasingly larger window sizes, not only to meet egress requirements, but to meet the preferences of many users toward windows, which allow more light into the building. However as window sizes increase, the distance between support points become larger, and window sash surface areas, which are subjected to external forces, also increases. The same can result in higher aggregate forces and torque relative to the support points, which need to be accounted for in the larger windows.

Additionally, municipalities are increasingly requiring stricter survivability guidelines through an adjustment of the appropriate building code requirements. As building codes requirements are adjusted to increase the minimal thresholds of the amount of various types of external forces that a window should be able to survive, window manufacturers are tasked with meeting the more stringent code requirements, or alternatively, would be faced with not being able to sell their product in the market for the areas having the more stringent code requirements. Consequently, window manufacturers are always looking for cost effective ways to enhance the survivability of windows under more extreme conditions, which does not materially affect the ease of use of the window for its intended purposes, or the features of the window, which have come to be expected and therefore may be an important purchasing criteria of the consumer. Consequently, it would be beneficial to develop changes in the window structure and/or window component structures, which provides additional support for maintaining a window sash within a window frame without materially impeding the normal expected usage including the ability of the sash to be able to readily tilt, when desired.

### SUMMARY OF THE INVENTION

A stile latch is provided, which includes a bolt adapted to extend at least partially into a slot, which aligns with the bolt in at least one predefined position along a path of travel of a sash within a frame, while the sash is substantially in plane with the frame. The bolt has a ramped facing, which is adapted to engage an edge of the slot, when the bolt moves from the aligned at least one predefined position toward an unaligned position in at least a first direction of substantially in plane travel. The stile latch further includes a tension device coupled to the bolt, which biases the bolt toward an extended position, that extends the bolt into the slot, when the bolt and the slot are aligned in the at least one predefined position.

In at least one embodiment of the invention, the bolt is coupled to a stile of the sash and is adapted to extend into a slot in a side jamb of the frame.

In at least a further embodiment, the bolt is coupled to a side jamb of the frame and is adapted to extend into a slot in a stile of the sash.

In a further aspect of the present invention, a window assembly is provided. The window assembly includes a window frame having a pair of oppositely facing side jambs, and at least one window sash, wherein the window sash is received within the window frame. Each window sash includes a top rail, a bottom rail, a pair of stiles, and one or more stile latches. Each stile latch includes a bolt adapted to extend at least partially into a slot, which aligns with the bolt in at least one predefined position along a path of travel of a sash within a frame, while the sash is substantially in plane with the frame. The bolt has a ramped facing, which is adapted to engage an edge of the slot, when the bolt moves from the aligned at least one predefined position toward an unaligned position in at least a first direction of substantially in plane travel. The stile latch further includes a tension device coupled to the bolt, which biases the bolt toward an extended position, that extends the bolt into the slot, when the bolt and the slot are aligned in the at least one predefined position.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a perspective view of a tiltable sash window;

FIG. 2 is a perspective view of the tiltable sash window, illustrated in FIG. 1, with a portion broken away and showing the lower sash being tilted out of the window frame;

FIG. 3 is a partial perspective view of an exemplary jamb liner and associated mounting and support hardware, in accordance with at least one embodiment of the present invention;

FIG. 4 is a partial perspective view of a side stile of a window sash assembly, as well as corresponding window components, for use in connection with the corresponding jamb liner and associated mounting and support hardware, illustrated in FIG. 3, in accordance with at least one embodiment of the present invention;

FIG. 5 is an exploded perspective view of the stile latch, illustrated in FIG. 4;

FIGS. 6A-6D are top, front, bottom and side isometric views of a bolt of the stile latch, illustrated in FIGS. 2-5;

FIGS. 7A-7C are top, front and side isometric views of a main housing of the stile latch for use with the bolt, illustrated in FIGS. 6A-6D;

FIG. 8 is a top view of an alternative embodiment of a stile latch;

FIG. 9 is a front view of an alternative embodiment of a bolt;

FIGS. 10A-10C are successive partial cut away side views of a window frame, which illustrate the interaction of a stile latch with a slot as the stile latch moves between aligned and unaligned positions, in accordance with at least one embodiment of the present invention;

FIG. 11 is a partial cut away side view of a window frame, which illustrates the interaction of a stile latch having the alternative embodiment of a bolt, shown in FIG. 9, with a slot.

### DETAILED DESCRIPTION OF THE PREFERRED EMBODIMENTS

While the present invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

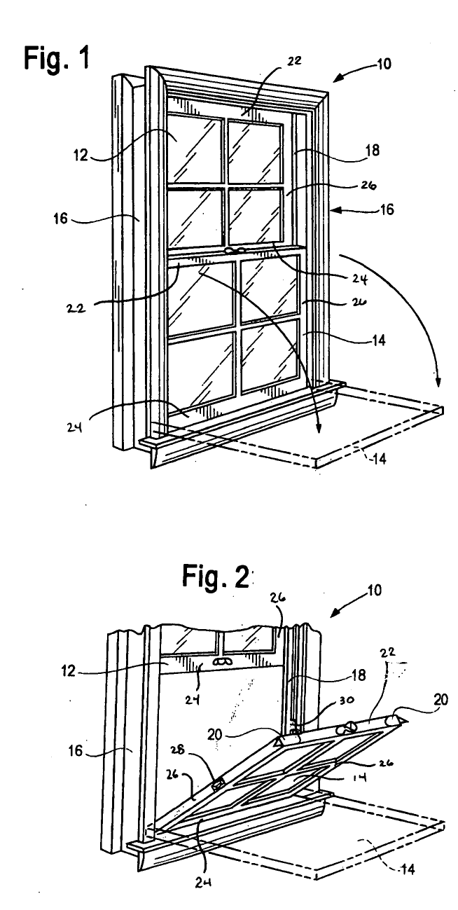

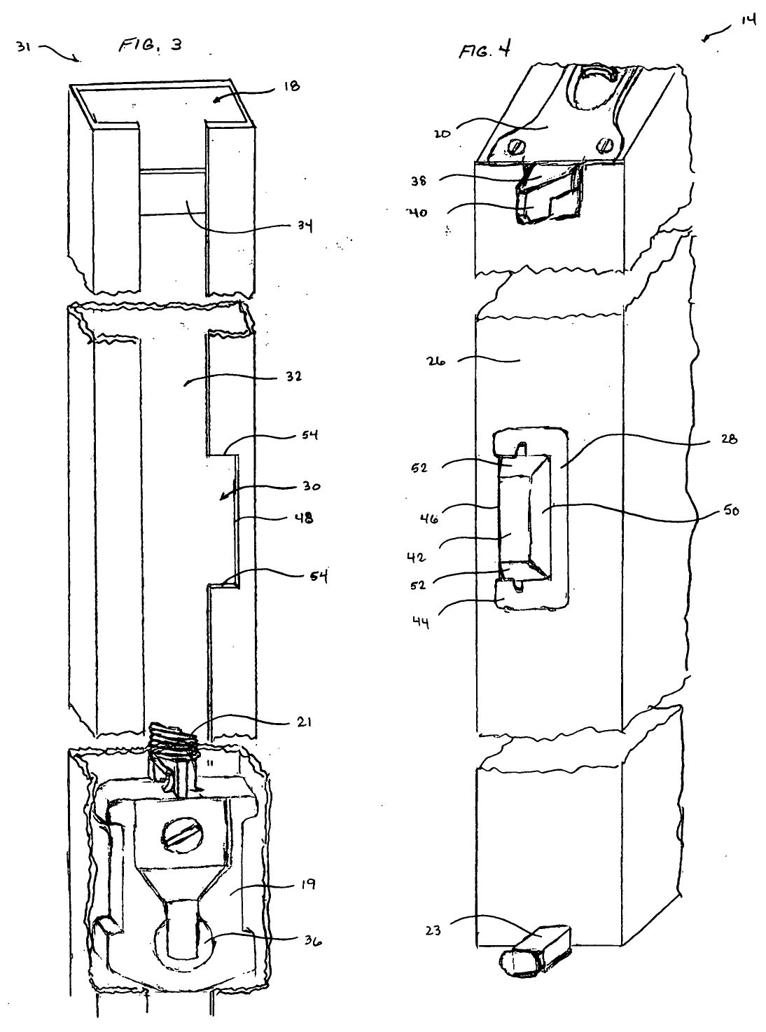

Referring now to the drawings in greater detail, there is illustrated in FIG. 1 a perspective view of a tiltable sash window assembly 10. The window assembly 10 has an upper outer (i.e. top) window sash 12 and a lower inner (i.e. bottom) window sash 14, which fit within two oppositely placed side jambs 16. Located within each of the two side jambs 16 is at least one jamb pocket 18. Coupled proximate to the top of at least the bottom window sash 14 is a pair of latch mechanisms 20 (FIG. 2), which are each located on opposite sides of the window sash 12, 14. The latch mechanisms 20 selectively engage the side jamb, and, while engaged, fix the top of the window sash 12, 14 relative to the side jamb 16. In at least some embodiments, a window sash balance shoe 19 and a tensioning device or spring 21 is located within each jamb pocket 18, which couples to the window sash and provides a counter balance force for the window sash 12, 14, examples of which are illustrated in FIG. 3.

The window sashes 12, 14 are each coupled to their corresponding window sash balance shoes 19 via a corresponding number (i.e. pair) of pivot bars 23, which are attached to the bottom of the window sashes 12, 14, an example of which is illustrated in FIG. 4. The pivot bar 23 allows the window sash 12, 14 to pivot between a vertical and a horizontal position as shown in FIGS. 1 and 2, when the latch mechanism 20, and correspondingly the top of the window sash 12, 14, is released from the side jamb 16.

In the illustrated embodiment, each window sash includes a top rail 22, a bottom rail 24, and a pair of side stiles 26. In at least the illustrated embodiment, a pair of latch mechanisms 20 are coupled to the top rail of at least the bottom sash. At least the bottom sash 14, additionally includes a pair of stile latches 28 which each selectively engages a corresponding slot 30. In FIG. 2, only the stile latch 28 associated with the left side stile can be seen, and the slot 30 associated with the right side stile, and the unseen right side stile latch, can be seen. In the illustrated embodiment, the stile latch 28 is coupled to the side stile 26 of the window sash, and the illustrated slot 30 is formed in the side jamb 16 of the window assembly 10.

FIG. 3 illustrates a partial perspective view of an exemplary jamb liner 31, which commonly forms at least part of a side jamb 16. FIG. 3 further illustrates associated mounting and support hardware, relative to the jamb liner 31, in accordance with at least one embodiment of the present invention. Relative to at least the illustrated embodiment, the jamb liner 31 includes at least one jamb pocket 18, and one or more openings 32 that run, at least partially, the length of the jamb liner 31. In many instances, the opening will have a length, which minimally enables the tilt bar 23 to laterally traverse unobstructed within the window frame in order to enable the intended lateral movement of the corresponding window sash 14. The window frame generally forms the portion of the window assembly 10, which defines the outer boundary of the assembly.

A window sash balance shoe 19, to which the tilt bar 23 of the sash 14 will commonly be received, and a corresponding tensioning device or spring 21 generally reside within the jamb pocket 18 of the side jamb 16. An example of each of a window sash balance shoe 19 and corresponding tensioning device/spring 21 are each described and illustrated in U.S. Pat. No. 5,697,188, entitled “Window Sash Balance Shoe with Friction Adjust Mechanism”, the disclosure of which is hereby incorporated by reference.

The tilt bar 23, as illustrated in FIG. 4, will generally be coupled to the bottom of the sash 14 and have an end, which can extend into the opening 32 of the jamb liner 31. In at least some instances, the end of the tilt bar 23, which extends into the opening 32 selectively couples to the window sash balance shoe 19, via a cam 36, which can rotate relative to the balance shoe 19, thereby enabling the tilt movement of the window sash 14, relative to the window frame. In some of these instances, the cam 36 may be adapted to lock the movement of the balance shoe within the jamb pocket, when the window sash 14 is tilted (i.e. such as out of plane) relative to the window frame.

In the illustrated embodiment, only a portion of the tensioning device/spring 21 is shown. In many instances, the spring 21 will extend from the window sash balance shoe 19 and extend and attach to the window frame proximate the top of the jamb pocket 18, or in the same or other instances at least as high as the intended movement of the corresponding sash 14. The tensioning device/spring is generally intended to provide a force, which helps to balance/offset the weight of the sash, thereby making the sash easier to move, often vertically and/or against the force of gravity, while the sash is within (i.e. substantially in plane relative to) the window frame.

In at least some instances, the one or more openings 32 can be interrupted and/or obstructed, at least partially, by a cross member or pocket brace 34, which is adapted to selectively engage a protrusion 40 at the end of a bolt 38, illustrated in FIG. 4, which forms part of a tilt latch or latch mechanism 20, which as previously noted is typically coupled to and/or mounted on the top rail 22 of at least the bottom sash 14. In at least some embodiments, the protrusion will move between an engaged position and a non-engaged position as the sash 14 moves within the window assembly 10, and more specifically the window frame, while remaining substantially non-tilted (i.e. in plane). In many window assemblies, the in plane or non-tilted movement is in a substantially vertical direction. In other instances, the in plane or non-tilted movement is in a substantially horizontal direction. The in plane movement of the sash will typically move in the direction of and along the length of the jamb 16. When the jamb is substantially horizontal, and correspondingly supports an in plane sash movement in a horizontal direction, the jamb can sometimes be referred to as a track. An example of a latch mechanism 20 and pocket brace 34 are each described and illustrated in U.S. patent application Ser. No. 10/325,622, entitled “A Latch Mechanism with Protrusion and Corresponding Pocket Brace”, filed Dec. 18, 2002, the disclosure of which is hereby incorporated by reference.

In the illustrated embodiment, the jamb liner 31, additionally includes a slot 30, which can be formed by cutting away a notch in the exposed facing of the jamb liner 31. The slot 30 can be separate from or overlap at least partially with the one or more openings 32 in the jamb liner 31, which provides tilt bar 23 access to the window sash balance shoe 19. The slot 30 is adapted to receive, a bolt 42 of a stile latch 28, when the bolt 42 is in alignment with the slot 30 in at least one corresponding predefined position. The stile latch 28 and corresponding bolt 42 is illustrated in FIG. 4, which is a partial perspective view of a side stile 26 of a window sash assembly. FIG. 4 additionally illustrates other window components, for use in connection with the corresponding jamb liner and associated mounting and support hardware, illustrated in FIG. 3, such as the latch mechanism 20 and tilt latch 23, discussed above.

In the illustrated embodiment, the stile latch 28 additionally includes a housing 44, which provides a pocket (illustrated more clearly in FIG. 5) having well formed surfaces within which the bolt 42 can be received and can travel. The housing can provide more detailed features, which can be specifically adapted to work with the bolt, while minimizing the impact upon a stile 26 which can sometimes be formed through an extrusion process, wherein an appropriately sized hole can be cut in the stile 26 at the desired location for receiving the housing 44 of the stile latch 28. The hole in the stile 26 within which the stile latch 28 is received is positioned to coincide with the corresponding slot 30 formed within the jamb liner 31, when the sash is in a predetermined position relative to the window frame. In at least one embodiment, the latch 28 will be in alignment with the slot 30, when the sash is in a closed position. For the lower sash 14, the closed position generally corresponds to the lowest vertical position within a window frame, which limits the movement of air between opposite sides of the window frame via the space outlined by the window frame. Relative to the sash 14, in at least one embodiment, the stile latch 28 is positioned proximately midway the length of the stile 26. Correspondingly, the slot 30 is appropriately positioned. While the illustrated embodiment includes a housing 44, one skilled in the art can readily appreciate that it is possible that the pocket formed by the housing 44 could alternatively be formed directly into the stile 26 of the sash 14 thereby enjoying at least some of the benefits provided by the housing 44 without the use of a separate element.

As noted previously, when the stile latch 28 is in alignment with the slot 30, the bolt 42 will extend into the slot 30. When the bolt 42 of the stile latch 28 extends into the slot 30, a bracing face 46 on the bolt is adapted to move behind, proximate to, and/or in contact with a bracing edge 48 of the slot 30. By moving behind, proximate to, and/or in contact with the bracing edge 48, the bracing face 46 of the bolt creates an area of overlap, which provides additional support against any out of plane movement of the sash 14, relative to the frame of the window assembly 10. In at least one embodiment, the bracing face 46 is proximately perpendicular to the direction of out of plane travel more likely to be induced by a differential between internal and external air pressure, such as the type which can be produced by extreme weather conditions.

In at least one embodiment, the bolt 42 is biased toward an extended position by a tension device, such as a spring 49, which is illustrated in FIG. 5. In at least some embodiments, the bolt 42 additionally includes a first deflecting surface 50, such as a ramped facing, which is adapted to interact with any exposed portion of the jamb liner 31 or other part of the window assembly, which might interfere with the bolt 42, when the bolt is in an extended position, and cause the bolt 42 to automatically deflect when the sash 14 moves (i.e. tilts) between an out of plane position to an in plane position relative to the frame of the window assembly 10. The first deflecting surface 50 can include a facing which is exposed to a corresponding portion of the jamb liner 31, when the bolt 42 is extended, at an angle, so as to deflect the bolt 42 away from an extended and interfering position into the housing 44 against the bias of the tension device 49, such that the bolt 42 will no longer interfere with the sash 14, when the sash 14 moves from the out of plane position toward the in plane position.

The bolt generally includes one or more deflecting surfaces 52, which are different from the sometimes optional first deflecting surface 50. Deflecting surface(s) 52 is adapted to interact with one or more corresponding edges 54, of the slot 30, when the bolt 42 is in an extended position, and moves between a position where the bolt 42 is aligned with the slot 30 and a position where the bolt is not aligned with the slot 30, relative to a lateral in plane movement of the sash while the sash is within the plane of the frame of the window assembly. The one or more deflecting surfaces 52 have respective facings which are exposed to the corresponding edges 54 at an angle so as to similarly deflect the bolt 42 away from an extended and interfering position, against the bias of the tension device, when the sash 14 moves from the aligned position to an unaligned position respective to each one of one or more slots 30. Each deflecting surface 52, where multiple deflecting surfaces are present, are ramped in a different direction to facilitate the proper deflection of the bolt 42 corresponding to the bolt/slot interaction in an opposite direction of lateral movement by the sash 14, while the sash 14 is in plane relative to the frame of the window assembly 10.

In at least some instances, the bolt 42 may only interact with the slot 30 in one direction of travel, as the aligned position is placed at a point where the bolt 42 is against one of the sides of the window frame in the direction of in plane travel, such as the bottom. In such instances, it may still be beneficial to include alternative ramped surfaces, corresponding to opposite directions of in plane travel, in order for the same part to be able to be alternatively installed on opposite stiles 26 in the window sash 14. In other instances, the bolt 42 may only include a single deflecting surface 52, relative to the particular direction of lateral, in plane, travel that the sash 14 is intended to move in order for the bolt 42 to exit the aligned position. In these instances, it may be beneficial to incorporate a tail on the opposite side of the bolt, further discussed below in connection with FIGS. 9 and 11, which is adapted to slide behind a corresponding edge 54 of the slot 30, which might not extend the full length of travel in the aligned position, as the sash 14 moves toward an extreme lateral position, such as the bottom, within the frame of the window assembly. Such an extreme lateral position may correspond to the position of a sash 14, within the window assembly, when the window is said to be closed. However, one skilled in the art will appreciate, that the inclusion of any such overlap is not restricted to when sash 14 is in an extreme position relative to the window assembly, but is likely to correspond proximately to the limit of lateral movement in a particular direction of in plane travel.

FIG. 5 illustrates an exploded perspective view of a stile latch 28, illustrated in FIG. 4. In the exploded view, the relationship of the spring 49 relative to the bolt 42 and the housing 44 is shown. In the illustrated embodiment, the housing 44 has a pocket 56 within which the bolt is received and can travel. In the illustrated embodiment, the pocket has a finite depth, which ends at the bottom 58 of the housing 44, which at least partially closes the end of the pocket 56, and forms a surface against which one end of the spring 49 can be braced. Respective notches 60 proximate the top of the internal portion of the sidewall 62 of the housing 44 provide a keyed surface along which a protrusion 64 on the side of the bolt 42 is received and retained during the expected travel of the bolt 42 within the housing 44. A pair of ridges 66, which extends from respective sides of the bolt proximate the bottom of the bolt, one of which can be seen in FIG. 5, travels within an opening 68 in the sidewall 62 of the housing 44. The ridges 66 interact with the top of the opening 68 in the sidewall 62 of the housing 44 to limit travel of bolt 42 within the pocket 56 of the housing 44 as it moves toward an extended position.

In the illustrated embodiment, the top of the bolt 42 includes an overhang 70 which includes the bracing face 46 and portions of the deflecting surface(s) 52. A notch 72 is formed at one edge of the pocket 56 proximate the top of the housing 44 for receiving the overhang 70 of the bolt 42. The housing further has a ridge 74 which extends circumferentially outward from the side of the housing 44, and which effectively limits the depth that the housing 44 can extend into an opening in the stile 26, as well as provides a smooth cosmetic finish at the top of the housing 44 proximate the opening in the stile 26. Prong like extensions 76 formed in the external surface of the housing 44 help retain the housing 44 within the stile 26.

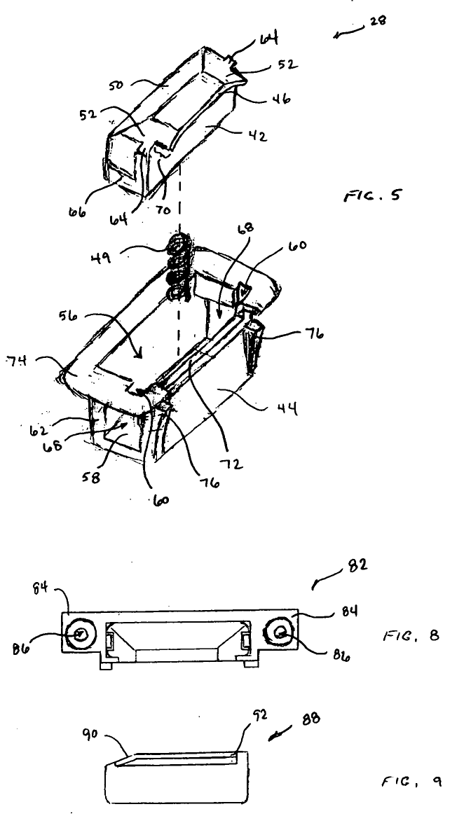

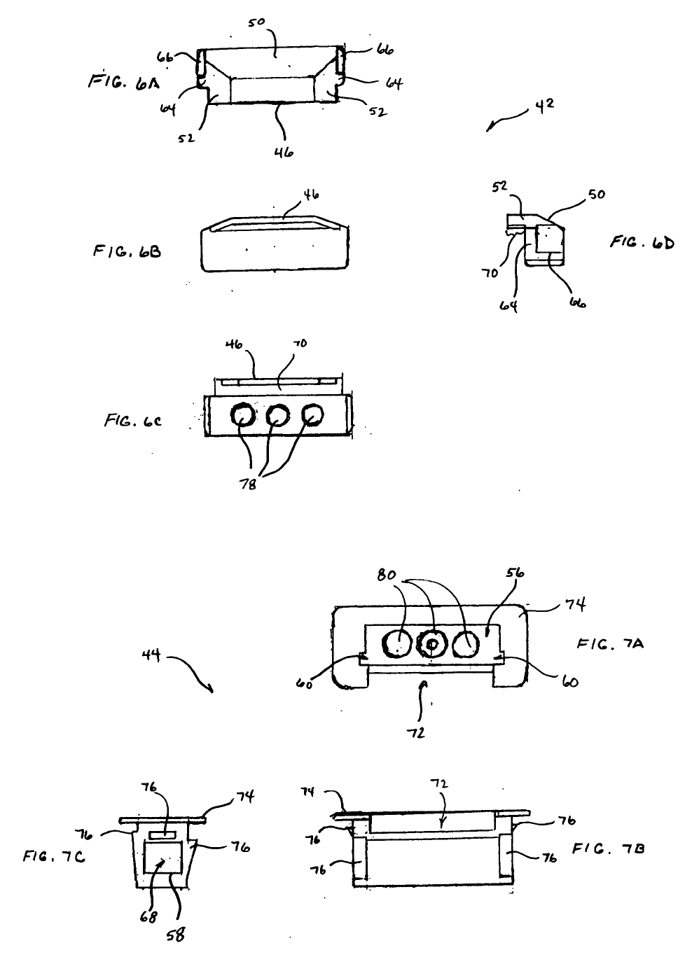

FIGS. 6A-6D illustrate top, front, bottom and side isometric views of a bolt 42 of the stile latch 28, illustrated in FIGS. 2-5, and FIGS. 7A-7C illustrate top, front and side isometric views of a main housing 44 of the stile latch 28 for use with the bolt 42, illustrated in FIGS. 6A-6D, relative to at least one embodiment of the present invention. The isometric views, in some instances may help to further illustrate at least some of the features of each of the bolt 42 and the housing 44, illustrated in other views. However some of the isometric views help illustrate further features, which can not be seen in the other non-isometric views. For example, FIG. 6C further illustrates three relatively shallow circular depressions 78, which are adapted for receiving one of the ends of up to three springs 49. The actual number of springs 49 used can be varied depending upon the desired amount and/or nature of the force for biasing the bolt in an extended position. While three positions 78 are illustrated for receiving an end of a spring 49, in at least one embodiment only one spring 49 is used. In the event that the number of springs desired were to exceed three, an alternate configuration could be used including a different number of depressions could be provided. Corresponding depressions 80 are similarly provided at the bottom 58 of the housing 44, illustrated in FIG. 7A. Additional prong like extensions 76 are further visible along other sides of the housing 44.

FIG. 8 illustrates a top view of an alternative embodiment of a stile latch 82. Stile latch 82 includes a relatively narrower profile, with slightly different side geometries associated with the pocket and the side of the bolt. Additionally, the housing includes side tabs 84 having countersunk openings 86 for receiving a fastener, and attaching the same to either a sash 14 or the side jamb of the window assembly 10.

FIG. 9 illustrates a front view of an alternative embodiment of a bolt 88. Whereas bolt 42 illustrated in FIGS. 2 and 4-6 included a pair of deflecting surface 52, bolt 88 has a single deflecting surface 90 and a tail 92 located opposite the deflecting surface 90, which is discussed above with respect to FIG. 4, and below with respect to FIG. 11.

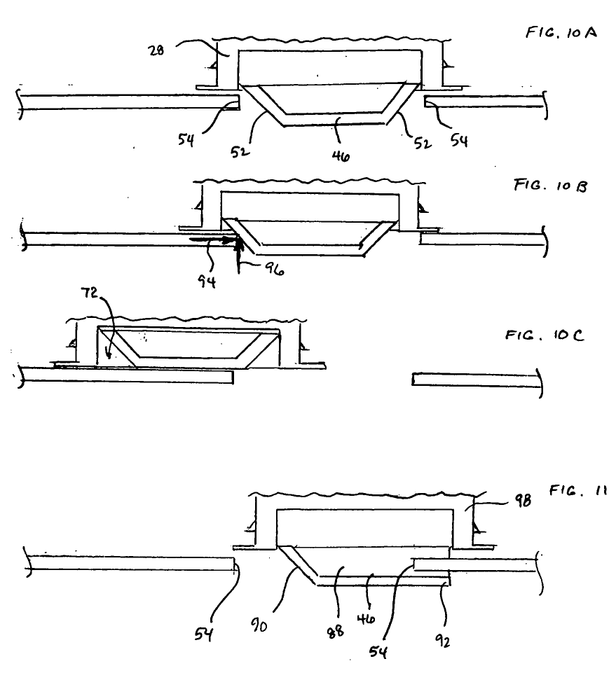

FIGS. 10A-10C illustrate successive partial cut away side views of a window frame, which illustrate the interaction of a stile latch with a slot as the stile latch moves between aligned and unaligned positions, in accordance with at least one embodiment of the present invention. More specifically, FIG. 10A illustrates an example where the bolt is aligned with the slot, and able to extend at least partially into the slot, which enables the bracing surface 46 to at least partially coincide with the bracing edge 48 of the slot 30 in order to resist any out of plane movement of the sash 14. As the sash 14 moves laterally in plane toward a position which is out of alignment, the deflecting surface 52 engages an edge 54 of the slot 30 in the direction of in plane travel at a point 94 along the ramped facing, thereby creating a biasing force 96, which has a force component which deflects the bolt 42 away from an extended position against the force of the spring 49, as shown in FIG. 10B. The bolt 42 will continue to retract as the sash moves further laterally, while in plane, until the bolt 42 is effectively no longer extended within the slot 30, as shown in FIG. 10C. At this point, the bracing surface 46 generally no longer coincides with the bracing edge 48, and as a result, the bolt is no longer positioned to resist out of plane movement, thereby enabling the sash to more readily tilt out of plane of the frame of the window assembly 10.

Where the bolt 42 and the slot 30 are positioned to be in alignment, when the window sash 14 is in a closed position, the lateral movement which causes the automatic release of the stile latch can coincide with an amount of movement sometimes required for the bottom of the sash 14 to clear the sill located at the bottom of many traditional windows. This minimal amount of movement for releasing the stile latch 28 can help prevent damage to the sash 14 or the sill, if one were to attempt to forceably tilt the window sash 14 before the bottom of the sash 14 has cleared the top of the sill.

FIG. 11 illustrates a partial cut away side view of a window frame, which illustrates the interaction of a stile latch 98 with a slot, where the stile latch 98 has the alternative embodiment of a bolt 88, shown in FIG. 9, which has a tail 90 in place of a second deflecting surface. In absence of a second deflecting surface, after the bolt 88 extends into the slot, the bolt 88 of the stile latch 98 can be adapted to extend beyond the unused interfering edge 54 thereby capturing the same at least partially behind the overhang 70 of the bolt 98. This greater amount of interaction between the bolt 98 and the slot 30 can provide a more substantial interaction between the bracing surface 46 and the bracing edge 48, thereby potentially providing even greater resistance to any attempted out of plane movement.

While the present invention has largely been described where the stile latch 28 is received in the side of the sash 14 and the slot is formed in the jamb liner 31, one skilled in the art will appreciate that the stile latch 28 could alternatively be received in an opening in the jamb liner and the slot 30 could alternatively be formed in the side of the sash 14 without departing from the teachings and while still enjoying the benefits of the present invention.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A stile latch comprising:
a bolt adapted to extend at least partially into a slot, which aligns with the bolt in at least one predefined position along a path of travel of a sash within a frame, while the sash is substantially in plane with the frame, said bolt having a ramped facing, which is adapted to engage an edge of the slot, when the bolt moves from the aligned at least one predefined position toward an unaligned position in at least a first direction of substantially in plane travel; and
a tension device coupled to the bolt, which biases the bolt toward an extended position, that extends the bolt into the slot, when the bolt and the slot are aligned in the at least one predefined position.

2. A stile latch in accordance with claim 1, wherein when the ramped surface engages the edge of the slot, the bolt is biased away from an extended position.

3. A stile latch in accordance with claim 1, wherein the bolt includes an opposite ramped facing, which is adapted to engage an opposite edge of the slot, when the bolt moves from the at least one aligned predefined position toward an unaligned position in a second direction of substantially in plane travel, which biases the bolt away from an extended position.

4. A stile latch in accordance with claim 1, wherein the bolt includes a tail having an end which is adapted to extend behind the slot beyond an opposite edge of the slot, while maintaining an engaged position, when the bolt moves from the at least one aligned predefined position toward an unaligned position in a second direction of substantially in plane travel.

5. A stile latch in accordance with claim 1, wherein the at least one aligned predefined position is located such that the bolt is aligned with the slot in the at least one predefined position when the sash is in a closed position, while substantially in plane, relative to the frame.

6. A stile latch in accordance with claim 5, wherein the bolt and slot are positioned, such that the bolt is adapted to extend into the slot proximate the middle of the sash, when the sash is in the closed position.

7. A stile latch in accordance with claim 1, wherein the bolt is coupled to a stile of the sash and is adapted to extend into a slot in a side jamb of the frame.

8. A stile latch in accordance with claim 1, wherein the bolt is coupled to a side jamb of the frame and is adapted to extend into a slot in a stile of the sash.

9. A stile latch in accordance with claim 1, wherein the path of travel of the sash within the frame is substantially vertical.

10. A stile latch in accordance with claim 1, wherein the path of travel of the sash within the frame is substantially horizontal.

11. A stile latch in accordance with claim 1, wherein the tension device is a spring.

12. A stile latch in accordance with claim 1, wherein the stile latch additionally comprises a housing having one or more sidewalls, which form a passage within which the bolt is received, and a backwall which at least partially closes one end of the passage, and wherein the tension device is located between the bolt and the backwall of the housing.

13. A stile latch in accordance with claim 12, wherein the housing has at least one ear extending out from at least one of the sidewalls of the housing, that has a hole through which a fastener couples the housing to at least one of the sash or the frame.

14. A stile latch in accordance with claim 12, wherein the housing has one or more prongs, which are adapted for press fitting the housing into at least one of the sash or the frame.

15. A stile latch in accordance with claim 1, wherein the slot is a cut out in a side jamb of the frame, which extends partially along the path of travel.

16. A stile latch in accordance with claim 1, wherein the bolt has an overhang adapted to extend the contact point of the bolt, relative to a side of the slot, when the bolt extends at least partially into the slot, in a direction that is approximately perpendicular to the direction of travel.

17. A stile latch in accordance with claim 1, wherein the sash is a window sash and the frame is a window frame.

18. A window assembly comprising:
a window frame having a pair of oppositely facing side jambs; and
at least one window sash, wherein the window sash is received within the window frame, each window sash including a top rail, a bottom rail, a pair of stiles, and one or more stile latches, each stile latch comprising
a bolt adapted to extend at least partially into a slot, which aligns with the bolt in at least one predefined position along a path of travel of a sash within a frame, while the sash is substantially in plane with the frame, said bolt having a ramped facing, which is adapted to engage an edge of the slot, when the bolt moves from the aligned at least one predefined position toward an unaligned position in at least a first direction of substantially in plane travel, and
a tension device coupled to the bolt, which biases the bolt toward an extended position, that extends the bolt into the slot, when the bolt and the slot are aligned in the at least one predefined position.

19. A window assembly in accordance with claim 18, wherein one or more of the at least one window sash is adapted to tilt relative to the plane of the window frame, via a pair of tilt bars, which extend between the window frame and the window sash

20. A window assembly in accordance with claim 19, wherein the bolt includes a tilt ramp facing, which is adapted to bias the bolt away from an extended position, when the sash moves from a tilt position to a non-tilt position.
